(19) United States
(12) Patent Application Publication
(10) Pub. No.: US 2026/0214597 A1
(43) Pub. Date: Jul. 23, 2026

(54) CARRIER WAVE EMISSION POWER CONTROL AND PERIODIC ENERGY HARVESTING FOR A BACKSCATTER DEVICE

(71) Applicant: QUALCOMM Incorporated, San Diego, CA (US)

(72) Inventors: Chao Wei, Beijing (CN); Mingxi Yin, Beijing (CN); Kangqi Liu, San Diego, CA (US); Hao Xu, Beijing (CN)

(21) Appl. No.: 19/140,525

(22) PCT Filed: Feb. 24, 2023
(86) PCT No.: PCT/CN2023/078074

§ 371 Date: Jun. 18, 2025

(51) Int. Cl. H04W 52/36; H02J 50/00; H04W 76/28

(52) U.S. Cl. CPC H04W 52/367; H02J 50/001; H04W 76/28

(57) ABSTRACT

Techniques for carrier wave emission and energy harvesting in a passive or semi-passive backscatter device are described. An apparatus may be configured to send, to a first network node, information indicative of power preferences for the apparatus, receive, from the first network node, a radio frequency (RF) signal, wherein the RF signal is based on the information, and transmit, based on a backscatter modulation of the RF signal, data to one or more of the first network node or a second network node.

### TECHNICAL FIELD

This disclosure relates generally to wireless communication systems, and more particularly, to techniques for carrier wave power control for use in energy harvesting and backscatter communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

Wireless communication systems may also be configured to communicate with one or more backscatter devices. Backscatter devices may be a type of radio frequency (RF) energy harvesting device. In general, RF energy harvesting devices are configured to capture and convert ambient RF signals, such as Wi-Fi, cellular, or radio signals, into usable electrical power, which can be used to perform one or more functions of the RF energy harvesting device.

As the demand for mobile broadband access continues to increase, research and development continue to advance wireless communication technologies not only to meet the growing demand for mobile broadband access, but to advance and enhance the user experience with mobile communications.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. Unless expressly described, no one aspect or feature is essential to achieve technical effects or solutions discussed herein.

Various aspects of the techniques of this disclosure relate to power control for a backscatter device. A backscatter device may be a type of RF energy harvesting device that is configured to capture and convert ambient RF signals, such as Wi-Fi, cellular, or radio signals, into usable electrical power, which can be used to perform one or more functions, including sending data using backscatter modulation of the incoming RF signal. In accordance with the techniques of this disclosure, a backscatter device may send information indicative of power preferences to a reader (e.g., a network node). The reader may be a user equipment (UE), such as a mobile phone, a network base station, or another RF emitter. The reader may use the information to perform open loop or closed loop power control for the backscatter device by adjusting the power of an RF signal sent to the backscatter device.

In examples of open loop power control, the information indicative of the power preferences may be information that the reader can use to estimate the amount of power that is available at the backscatter device for energy harvesting. In some examples, the information may include modulation types, impedance states, and associated reflection coefficients. In other examples, the information may include power ratio differences between power available for energy harvesting and power available for backscatter modulation. The reader may measure a received backscattered power and then estimate the power available for energy harvesting based on the information. If the estimated power available for energy harvesting differs from a target power, the reader may increase or decrease the power of subsequent RF signals sent to the backscatter device.

In examples of closed loop power control, the reader may receive information from the backscatter device that directly indicates whether to increase or decrease power of the RF signal. In other examples, the information sent from the backscatter device to the reader may include information that indicates the periodicity and/or timing windows of the RF signals so as to avoid having the backscatter device enter a sleep state (e.g., a cold start state), which may require an undesirably long start up time.

The techniques of this disclosure may allow one or more readers to determine a more optimal amount of power to use for the ambient RF signal used by a backscatter device to harvest energy and transmit data via backscatter modulation. In addition, the techniques of this disclosure may allow a reader to determine a more optimal periodicity for transmitting RF signals to backscatter devices, thus reducing the likelihood that a backscatter device will enter a cold start state. Keeping a backscatter device from entering a cold start state may improve data transmission speed and/or data transmission reliability for certain use cases.

In one example, this disclosure describes an apparatus for passive wireless communication, the apparatus comprising one or more processors, and a memory accessible by the one or more processors, wherein the one or more processors are configured to send, to a first network node, information indicative of power preferences for the apparatus, receive, from the first network node, a radio frequency (RF) signal, wherein the RF signal is based on the information, and transmit, based on a backscatter modulation of the RF signal, data to one or more of the first network node or a second network node.

In another example, this disclosure describes a network node for passive wireless communication, the network node comprising one or more processors, and a memory accessible by the one or more processors, wherein the one or more processors are configured to receive, from a backscatter device, information indicative of power preferences for the backscatter device, send, to the backscatter device, an RF signal, wherein the RF signal is based on the information, and receive data from the backscatter device based on a backscatter modulation of the RF signal by the backscatter device.

In another example, this disclosure describes a method for passive wireless communication by a backscatter device, the method comprising sending, to a first network node, information indicative of power preferences for the backscatter device, receiving, from the first network node, an RF signal, wherein the RF signal is based on the information, and transmitting, based on a backscatter modulation of the RF signal, data to one or more of the first network node or a second network node.

In another example, this disclosure describes a method for passive wireless communication, the method comprising receiving, from a backscatter device, information indicative of power preferences for the backscatter device, sending, to the backscatter device, an RF signal, wherein the RF signal is based on the information, and receiving data from the backscatter device based on a backscatter modulation of the RF signal by the backscatter device.

In another example, this disclosure describes an apparatus for passive wireless communication, the apparatus comprising means for sending, to a first network node, information indicative of power preferences for a backscatter device, means for receiving, from the first network node, an RF signal, wherein the RF signal is based on the information, and means for transmitting, based on a backscatter modulation of the RF signal, data to one or more of the first network node or a second network node.

In another example, this disclosure describes an apparatus for passive wireless communication, the apparatus comprising means for receiving, from a backscatter device, information indicative of power preferences for the backscatter device, means for sending, to the backscatter device, an RF signal, wherein the RF signal is based on the information, and means for receiving data from the backscatter device based on a backscatter modulation of the RF signal by the backscatter device.

In another example, this disclosure describes a non-transitory computer-readable storage medium storing instructions that, when executed cause one or more processors to send, to a first network node, information indicative of power preferences for the apparatus, receive, from the first network node, an RF signal, wherein the RF signal is based on the information, and transmit, based on a backscatter modulation of the RF signal, data to one or more of the first network node or a second network node.

In another example, this disclosure describes a non-transitory computer-readable storage medium storing instructions that, when executed cause one or more processors to receive, from a backscatter device, information indicative of power preferences for the backscatter device, send, to the backscatter device, an RF signal, wherein the RF signal is based on the information, and receive data from the backscatter device based on a backscatter modulation of the RF signal by the backscatter device.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF DRAWINGS

FIG. 1 illustrates an example of a wireless communications system 100 that supports carrier wave emission power control and periodic energy harvesting for a backscatter device in accordance with one or more aspects of the present disclosure.

FIG. 2 illustrates examples of full duplex communication between a reader and a backscatter device in accordance with one or more aspects of the present disclosure.

FIG. 3 illustrates examples of half duplex communication between multiple readers and a backscatter device in accordance with one or more aspects of the present disclosure.

FIG. 4 is a block diagram illustrating an example communication between a reader and a backscatter device in accordance with one or more aspects of the present disclosure.

FIG. 5 is a block diagram of an example backscatter device in accordance with one or more aspects of the present disclosure.

FIG. 6 is a block diagram illustrating an example technique for power control in a backscatter device in accordance with one or more aspects of the disclosure.

FIG. 7 is a timing diagram for transmitting an RF signal for energy harvesting in accordance with one or more aspects of the present disclosure.

FIG. 8 is a call flow diagram illustrating an example of carrier wave emission power control in accordance with one or more aspects of the present disclosure.

FIG. 9 is a call flow diagram illustrating another example of carrier wave emission power control in accordance with one or more aspects of the present disclosure.

FIG. 10 is a block diagram illustrating an example of a hardware implementation for a network node according to some aspects of this disclosure.

FIG. 11 is a flowchart illustrating another example of a process for power control in a backscatter device according to some aspects of this disclosure.

FIG. 12 is a flowchart illustrating another example of a process for power control in a backscatter device according to some aspects of this disclosure.

### DETAILED DESCRIPTION

Wireless communications systems may include multiple communication devices such as user equipment (UEs) and base stations (e.g., network entities), which may provide wireless communication services to the UEs. For example, such base stations may be next-generation NodeBs or giga-NodeBs (either of which may be referred to as a gNB) that may support multiple radio access technologies (RATs) including fourth generation (4G) systems, such as Long Term Evolution (LTE) systems, as well as fifth generation (5G) systems, which may be referred to as New Radio (NR) systems. Some UEs may support reference signal transmission, reception, and reporting.

UEs and network entities of a wireless communication system may be configured to communicate with one or more backscatter devices. Backscatter devices may be a type of RF energy harvesting device. In general, RF energy harvesting devices are configured to capture and convert ambient RF signals, such as Wi-Fi, cellular, or radio signals, into usable electrical power, which can be used to perform one or more functions of the RF energy harvesting device. Some example RF energy harvesting devices can operate in a wide range of RF frequencies. The efficiency of these devices is dependent on various factors, such as the antenna design and the rectifier efficiency. The amount of energy harvested by an RF energy harvesting device is typically low and depends on the strength of the RF signal and the proximity of the device to the RF source (e.g., UEs or network entities).

RF energy harvesting devices are commonly used in applications such as wireless sensor networks, internet of things (IoT) devices, and other low-power electronic devices. These devices can eliminate the need for traditional batteries or power supplies, reducing maintenance costs, and improving the sustainability of these systems. RF energy harvesting devices can also be used to supplement the power supply of other electronic devices, extending their battery life or reducing the need for frequent charging.

The basic architecture of an RF energy harvesting device may include an antenna, a rectifier, a microcontroller, and a sensor. The antenna is designed to capture RF signals from the environment and convert the RF signals into an AC voltage signal. The rectifier is used to convert this AC signal into a DC voltage signal, which can be used to power the microcontroller and sensor. The microcontroller may read data from the sensor and control the reflection coefficient of the antenna to perform a backscatter modulation of the incoming RF signal to send data to one or more readers.

The backscatter modulation process may include two devices: a reader and the backscatter device. The reader sends a continuous wave (CW) signal (e.g., RF signal) at a specific frequency to backscatter device. Backscatter device absorbs some of the energy of the signal and reflects the remaining energy back to the reader. By modulating the amplitude or frequency of the reflected signal, backscatter device can transmit information (e.g., data) to the reader.

In the context of a wireless communication system, the readers may be one or more UEs and/or network entities (e.g., a gNB). This disclosure may generically refer to a reader as a network node, where the term network node may encompass any device configured to receive backscatter communications from backscatter device.

Recently, ambient IoT (e.g., passive IoT) technology has attracted attention in 3GPP. Some example ambient IoT technologies target low complexity and low power devices providing complexity and power consumption orders of magnitude lower than existing technologies, such as enhanced machine-type communication (eMTC) and/or narrowband IoT (NB-IoT). Ambient IoT devices (e.g., a backscatter device) are generally classified into two types. Type A ambient IoT devices are devices with no energy storage capability (e.g., no batteries) and are completely dependent on the availability of an external source of energy (e.g., an RF signal/CW). Type B ambient IoT devices have limited energy storage (e.g., super capacity or conventional capacity) that do not need to be replaced or recharged manually.

Currently, power control for backscatter devices (e.g., controlling power of the ambient RF signal) is difficult, as the readers do not have any mechanism to determine the amount of power harvested by the backscatter device. In some examples, a backscatter device may operate according to a minimum RF input power requirement (e.g., −20 dBm for battery-less devices) for energy harvesting. However, too high of an input power may over charge the rectifier and cause energy waste. As such, it is preferable that the harvested power by the backscatter device provides a minimum level power for harvesting power from the RF signal from the reader and for modulating the backscattered signal to the reader.

For backscatter communications, a faster frequency for switching antenna impedance can achieve high data rate. However, a faster frequency for antenna switching may increase power consumption. Therefore, the harvested power may typically determine the maximum data rate, especially for battery-less devices for which power comes directly from the input RF signal

Therefore, information that is indicative of the harvested power at the passive backscatter device may be beneficial for more efficient scheduling of backscatter communication to the reader. In addition, information that is indicative of the harvested power at the passive backscatter device may enable a reader to perform power control of the RF signal (e.g., CW) to support more efficient energy harvesting.

Another problem with some example backscatter devices is related to the initial power-up duration and periodic nature of the transmission of the ambient RF signals (e.g., the CWs). For backscatter devices with limited energy storage, when the backscatter device is powered off due to unavailability of energy sources and cannot provide enough power to charge the microcontroller and/or storage elements of the backscatter device, the voltage available on the backscatter device may drop below a critical level, resulting in the circuits of the backscatter device entering sleep state (e.g., a cold start state).

To prevent from entering a cold start state, for which the initial charge time can be significant (e.g., hundreds of ms dependent on the size of the connected capacity), it is preferable to periodically transmit an RF signal to the backscatter device to keep the device in the active state. However, periodic RF signal transmission may cause energy waste if the backscatter device is in good power state or has no data to transmit. Periodic RF signal transmission and may also create unnecessary interference to communication signals.

This disclosure describes techniques that may address one or more of the problems described above for passive backscatter devices. In particular, this disclosure describes various signaling techniques that allow one or more readers to determine a more optimal amount of power to use for the ambient RF signal used by a backscatter device to harvest energy and transmit data via backscatter modulation. In addition, the techniques of this disclosure may allow a reader to determine a more optimal periodicity and/or timing window for transmitting RF signals to backscatter devices, thus reducing the likelihood that a backscatter device will enter a cold start state. Keeping a backscatter device from entering a cold start state may improve data transmission speed and/or data transmission reliability for certain use cases.

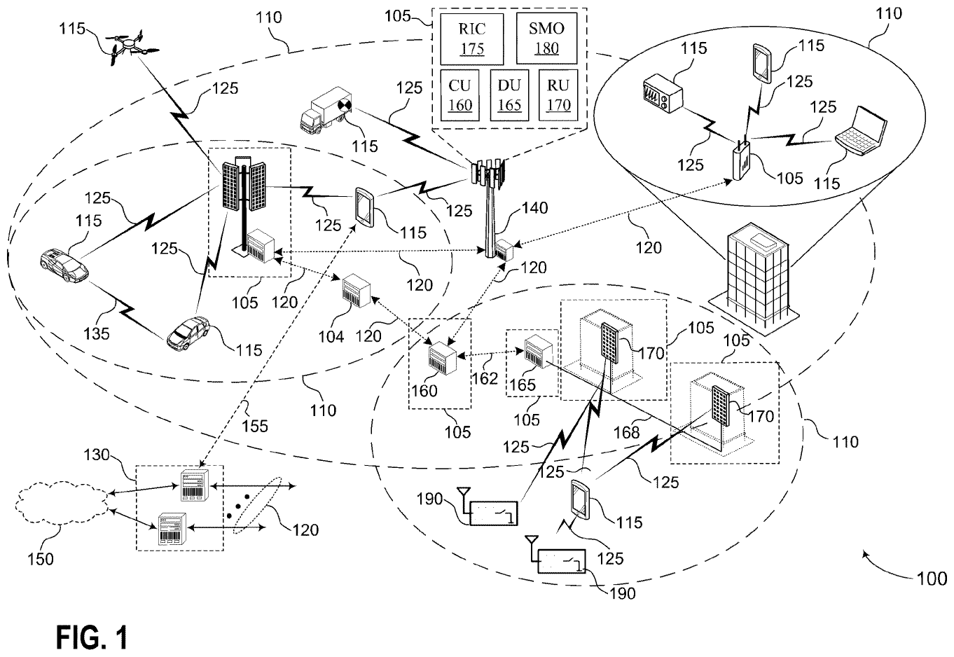

FIG. 1 illustrates an example of a wireless communications system 100 that supports carrier wave emission power control and periodic energy harvesting for a backscatter device in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a network node, a base station, a gNB, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

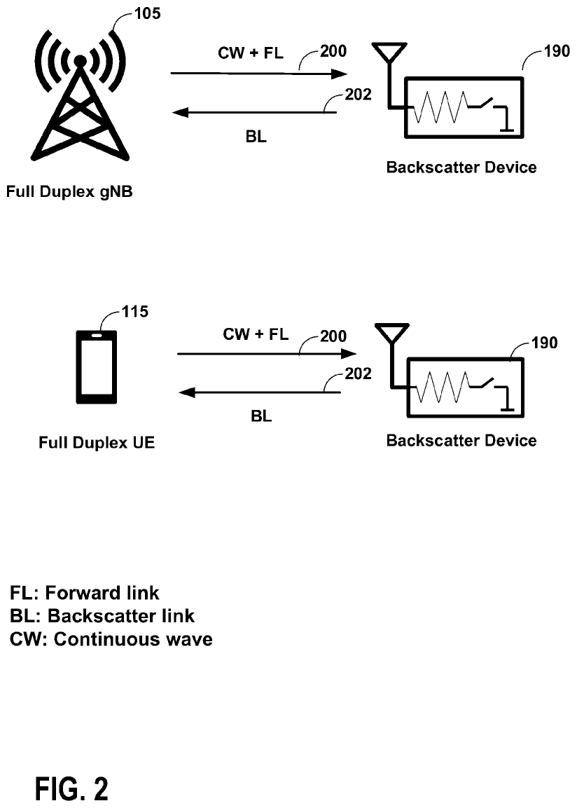

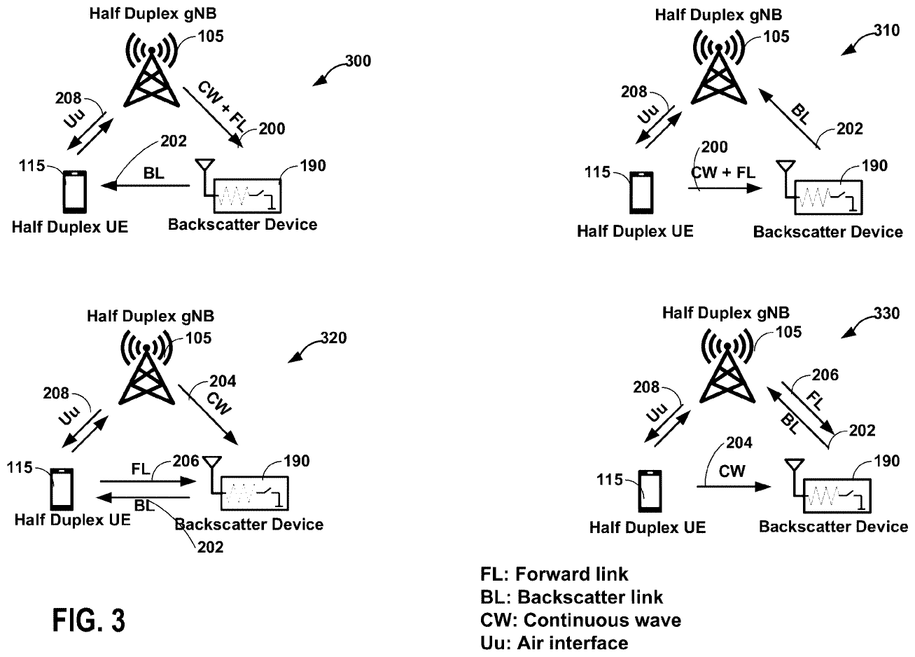

The UEs 115 may be dispersed throughout a coverage area 110 of the wireless communications system 100, and each UE 115 may be stationary, mobile, or both at different times. In some examples, one or more of UEs 115 may be energy harvesting (EH) capable devices, such as passive or semi-passive backscatter device. Examples of backscatter devices will be discussed in more detail below with reference to FIGS. 2 and 3. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein for reference signal processing during a DRX inactive time. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a Node, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support the processing of reference signals during a DRX inactive time as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, a network node, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of an RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Wireless communication system 100 may also be configured to communicate with one or more backscatter devices 190. Backscatter devices 190 may be a type of RF energy harvesting device. In general, RF energy harvesting devices are configured to capture and convert ambient RF signals, such as Wi-Fi, cellular, or radio signals, into usable electrical power, which can be used to perform one or more functions of the RF energy harvesting device. Some example RF energy harvesting devices can operate in a wide range of RF frequencies. The efficiency of these devices is dependent on various factors, such as the antenna design and the rectifier efficiency. The amount of energy harvested by an RF energy harvesting device is typically low and depends on the strength of the RF signal and the proximity of the device to the RF source (e.g., UEs 115 and/or network entities 105).

RF energy harvesting devices are commonly used in applications such as wireless sensor networks, internet of things (IoT) devices, and other low-power electronic devices. These devices can eliminate the need for traditional batteries or power supplies, reducing maintenance costs, and improving the sustainability of these systems. RF energy harvesting devices can also be used to supplement the power supply of other electronic devices, extending their battery life or reducing the need for frequent charging.

The basic architecture of an RF energy harvesting device may include an antenna, a rectifier, a microcontroller, and a sensor. The antenna is designed to capture RF signals from the environment and convert the RF signals into an AC voltage signal. The rectifier is used to convert this AC signal into a DC voltage signal, which can be used to power the microcontroller and sensor. The microcontroller may read data from the sensor and control the reflection coefficient of the antenna to perform a backscatter modulation of the incoming RF signal to send data to one or more readers.

The backscatter modulation process may include two devices: a reader and the backscatter device. The reader sends a continuous wave (CW) signal (e.g., RF signal) at a specific frequency to backscatter device 190. Backscatter device 190 absorbs some of the energy of the signal and reflects the remaining energy back to the reader. By modulating the amplitude, phase, or frequency of the reflected signal, backscatter device 190 can transmit information (e.g., data) to the reader.

In the context of wireless communication system 100, the readers may be one or more UEs 115 and/or network entities 105. This disclosure may generically refer to a reader as a network node, where the term network node may encompass any device configured to receive backscatter communications from backscatter device 190, including UEs 115 and network entities 105. Backscatter devices 190 may be passive or semi-passive backscatter devices in that that may have no internal storage capacity (e.g., a passive backscatter device) or very limited internal power storage capacity (e.g., a semi-passive backscatter device). In other contexts, backscatter devices 190 may be referred to as tags, EH tags, radio frequency identification (RFID) tags, passive UEs (PUEs), backscatter UEs (BUEs), ambient internet-of-things (IoT) devices, passive IoT devices, and/or wireless sensor nodes.

FIG. 2 illustrates examples of full duplex communication between a reader and a backscatter device in accordance with one or more aspects of the present disclosure. In one example, the reader is a network entity 105. FIG. 2 shows network entity being a gNB. However, network entity 105 may be any type of base station. In another example, the reader is a UE 115.

In the example of FIG. 2, the network entity 105 or UE 115 is in full duplex communication with backscatter device 190. Full duplex communication means that the reader sends the continuous wave (CW) and forward link (FL) 200 to the backscatter device 190, and then receives the backscatter link (BL) 202 from the backscatter device 190. The FL may include control signaling for backscatter device 190. The CW is an RF signal that serves as both the energy source for the backscatter device 190, as well as the carrier signal for backscatter communications. The BL 202 carries data from the backscatter device 190 to the reader.

FIG. 3 illustrates examples of half duplex communication between multiple readers and a backscatter device in accordance with one or more aspects of the present disclosure. In the example of FIG. 3, different readers may be handle different parts of the transmission and receptions in relation to backscatter device 190. In scenario 300, the network entity 105 sends the CW and FL 200 to the backscatter device 190. The backscatter device 190 then sends the BL 202 to UE 115. The network entity 105 and the UE 115 may be in communication with each other over air interface (Uu) link 208. In scenario 310, the UE 115 sends the CW and FL 200 to the backscatter device 190. The backscatter device 190 then sends the BL 202 to the network entity 105. Again, the network entity 105 and the UE 115 may be in communication with each other over (Uu) link 208.

Scenarios 320 and 330 show examples where the CW and FL are not the same signal. That is FL information may come from one reader, but the CW (e.g., RF signal used for power) comes from a different reader. In scenario, 320, the network entity 105 sends a CW 204 to the backscatter device 190. However, the UE 115 sends a FL 206 to the backscatter device. The backscatter device 190 sends the BL 202 to the UE 115. In other examples, the backscatter device 190 sends the BL 202 to the network entity 105.

In scenario 330, the UE 115 sends the CW 204 to the backscatter device 190. However, the network entity 105 sends the FL 206 to the backscatter device. The backscatter device 190 sends the BL 202 to the network entity 105. In other examples, the backscatter device 190 sends the BL 202 to the UE 115.

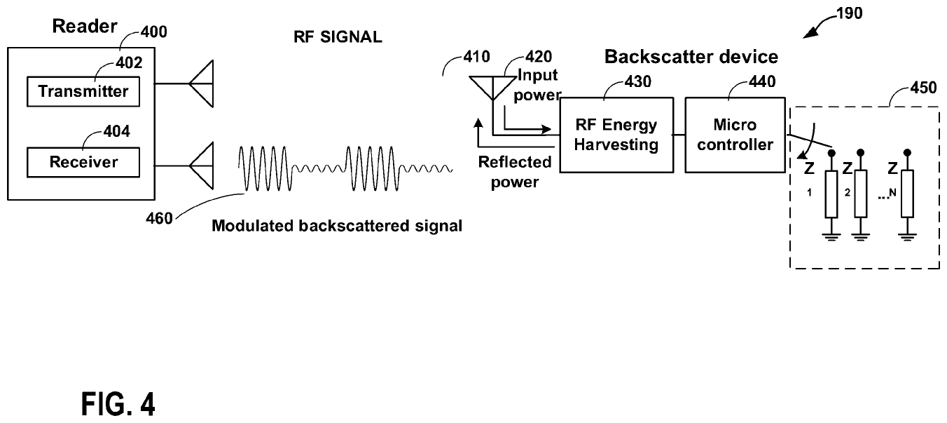

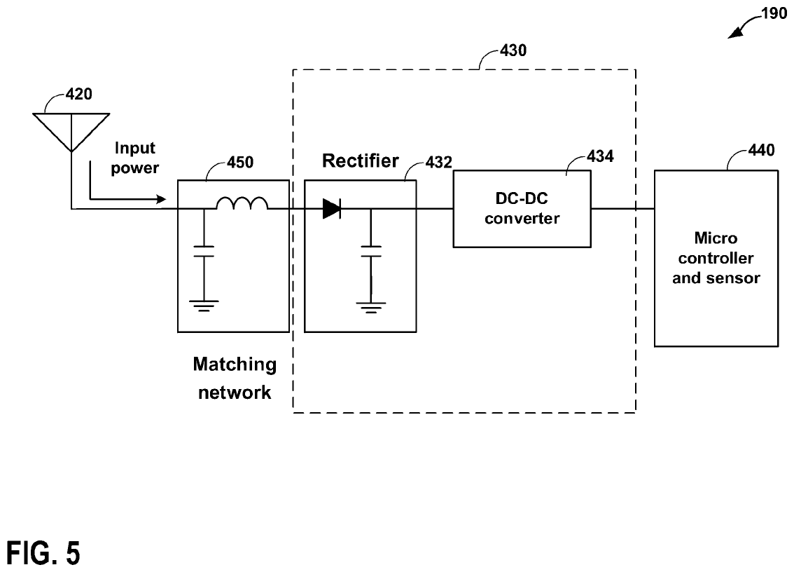

FIG. 4 is a block diagram illustrating an example backscatter communication between a reader and a backscatter device in accordance with one or more aspects of the present disclosure. FIG. 4 shows a reader 400 in communication with a backscatter device 190. The reader 400 may be any network node, such as UE 115 and/or network entity 105. The transmitter 402 of the reader 400 may transmit an RF signal 410. The RF signal 410 may be a CW or any ambient RF signal. The RF signal 410 is received at the antenna 420 of the backscatter device 190. The received RF signal 410 represents the potential input power that may be used by the RF energy harvesting circuit 430. Techniques for energy harvesting will be discussed below with reference to FIG. 5.

In backscatter communications, the information transmission is performed by antenna modulation which does not involve active RF generation. The micro controller 440 of the backscatter device 190 tunes the reflection coefficient of its antenna 420 by switching over a given set of impedances in matching network 450, resulting in a varying amount of modulated backscattered signal 460 (e.g., the reflected power). The modulated backscattered signal 460 may be received and demodulated by receiver 404 of reader 400.

When using amplitude shift keying (ASK) modulation or On/Off keying (OOK) modulation, the micro controller 440 of the backscatter device 190 switches the value of the load impedance of matching network 450 between a relatively high impedance and a relatively matched load. In the high impedance case, the mismatch between the antenna 420 and the load impedance of matching network 450 would reflect most of the power back to the reader 400. In the matched case, most of the power from the incoming RF signal 410 is absorbed and very little power is reflected to the reader 400. In one example, the impedance switching frequency is based on the desired data rate.

When the antenna 420 receives the RF signal 410 with power P, the power is transmitted from the antenna 420 to the matching network 450, while a part of power will be reflected from the matching network 450 to the antenna 420 with the reflection coefficient

$$Γ = \frac{{Z}_{L} - {Z}_{A}^{*}}{{Z}_{L} + {Z}_{A}} = \vert Γ \vert {e}^{j φ}$$

(e.g., as in Kurokawa's formula), where Z_{A}=Rₐ+jXₐ is the complex antenna impedance and Z_{L}=R_{L}+jX_{L} is the complex chip (load) impendence. The reflected power |Γ|²P is then radiated from the antenna 420.

FIG. 5 is a block diagram of an example backscatter device in accordance with one or more aspects of the present disclosure. FIG. 5 shows the RF energy harvesting circuit 430 in more detail. In this example, RF energy harvesting circuit 430 includes a rectifier 432 and a DC-DC converter 434. The matching network 450 may also be considered as part of the RF energy harvesting circuit 430 in some examples.

The matching network 450 operates as described above. The rectifier 432 is used to convert the RF signal to a DC voltage. The rectifier 432 may be based on Schottky diodes, complementary metal-oxide semiconductor (CMOS) diodes, backward tunnel diodes, or other similar diode implementations. The efficiency of the RF-DC conversion is a non-linear function of the input signal (e.g., power, waveform, and frequency) and may also depend on the structure of the DC-DC converter 434. As some examples, the conversion efficiency may be 2% at 1 uW (microwatt), 15% at 10 uW, and 35% at 100 uW for a single-diode rectifier.

The voltage of the DC signal from the rectifier 432 is typically hundreds of mV, e.g., 300 mV. The DC-DC converter 434 boosts the voltage of the DC signal output by the rectifier 432 to a predetermined target voltage (e.g., 1.8-2.4V). In some examples, the DC-DC converter 434 has a minimum input voltage threshold (e.g., 300 mV) below which the DC-DC converter 434 cannot operate. In some examples, the DC-DC converter 434 may be configured to operate at a higher voltage threshold for battery-free backscatter device configurations due to cold start limitations. For the DC-DC conversion, the delay time from when the input power is available until the output achieves target voltage can be significant depending on the size of the used capacity, e.g., from hundreds of microseconds to several seconds.

In some examples, a single-diode rectifier configuration is preferred at low power (1-500 uW). Multiple diode rectifiers may be preferable for higher input powers (>500 uW). An example multiple diode rectifier configuration may include a voltage doubler, a diode bridge, and a charge pump.

A battery-free backscatter device configuration may be configured to start all hardware components from cold start (0V) while a battery-charging backscatter device configuration can use the connected battery to provide a non-zero voltage value allowing higher sensitivities. Below-30 dBm (1 uW), a Schottky diode is not easily turned on.

In some example configurations, the backscatter device 190 may be configured to operate once a reader has transmitted an RF signal (e.g., the CW) for a predetermined amount of time (e.g., at least 400 us, more than 400 μs, or 0 to 1500 μs) to power up the backscatter device 190. In some examples, the minimum RF input power to the backscatter device 190 is-20 dBm.

Recently, ambient IoT (e.g., passive IoT) technology has attracted attention in 3GPP. Some example ambient IoT technologies target low complexity and low power devices providing complexity and power consumption orders of magnitude lower than existing technologies, such as enhanced machine-type communication (eMTC) and/or narrowband IoT (NB-IoT). Ambient IoT devices (e.g., backscatter device 190) are generally classified into two types. Type A ambient IoT devices are devices with no energy storage capability (e.g., no batteries) and are completely dependent on the availability of an external source of energy (e.g., an RF signal/CW). Type B ambient IoT devices have limited energy storage (e.g., super capacity or conventional capacity) that do not need to be replaced or recharged manually.

As described above, ambient IoT devices, like backscatter device 190, are typically passive and are not equipped with active RF components. Rather, the ambient IoT devices use backscatter modulation to transmit data. For example, backscatter device 190 may perform data transmission based on modulating an incident RF signals emitted by an ambient transmitter (e.g., UEs 115 and/or network entities 105). Ambient RF signals serve as not only the signal resource for backscatter modulation, but also energy resources for harvesting.

RFID is one existing battery-less technology; however, the limited reading range of a few meters makes it difficult to support a large-scale deployment with seamless coverage. Current backscatter and/or energy harvesting devices, such as RFID, may exhibit the following drawbacks.

Currently, power control for backscatter devices (e.g., controlling power of the ambient RF signal) is difficult, as the readers do not have any mechanism to determine the amount of power harvested by the backscatter device. In some examples, a backscatter device may operate according to a minimum RF input power requirement (e.g., −20 dBm for battery-less devices) for energy harvesting. However, too high of an input power may over charge the rectifier and cause energy waste. As such, it is preferable that the harvested power by the backscatter device provides a minimum level power for harvesting power from the RF signal from the reader and for modulating the backscattered signal to the reader.

For backscatter communications, a faster frequency for switching antenna impedance can achieve high data rate. However, a faster frequency for antenna switching may increase power consumption. Therefore, the harvested power may typically determine the maximum data rate, especially for battery-less devices for which power comes directly from the input RF signal

Therefore, information that is indicative of the harvested power at the passive backscatter device may be beneficial for more efficient scheduling of backscatter communication to the reader. In addition, information that is indicative of the harvested power at the passive backscatter device may enable a reader to perform power control of the RF signal (e.g., CW) to support more efficient energy harvesting.

Another problem with some example backscatter devices is related to the initial power-up duration and periodic nature of the transmission of the ambient RF signals (e.g., the CWs). For backscatter devices with limited energy storage, when the backscatter device is powered off due to unavailability of energy sources and cannot provide enough power to charge the microcontroller and/or storage elements of the backscatter device, the voltage available on the backscatter device may drop below a critical level, resulting in the circuits of the backscatter device entering sleep state (e.g., a cold start state).

To prevent from entering a cold start state, for which the initial charge time can be significant (e.g., hundreds of ms dependent on the size of the connected capacity), it is preferable to periodically transmit an RF signal to the backscatter device to keep the device in the active state. However, periodic RF signal transmission may cause energy waste if the backscatter device is in good power state or has no data to transmit. Periodic RF signal transmission and may also create unnecessary interference to communication signals.

This disclosure describes techniques that may address one or more of the problems described above for passive backscatter devices. In particular, this disclosure describes various signaling techniques that allow one or more readers to determine a more optimal amount of power to use for the ambient RF signal used by a backscatter device to harvest energy and transmit data via backscatter modulation. In addition, the techniques of this disclosure may allow a reader to determine a more optimal periodicity for transmitting RF signals to backscatter devices, thus reducing the likelihood that a backscatter device will enter a cold start state. Keeping a backscatter device from entering a cold start state may improve data transmission speed and/or data transmission reliability for certain use cases.

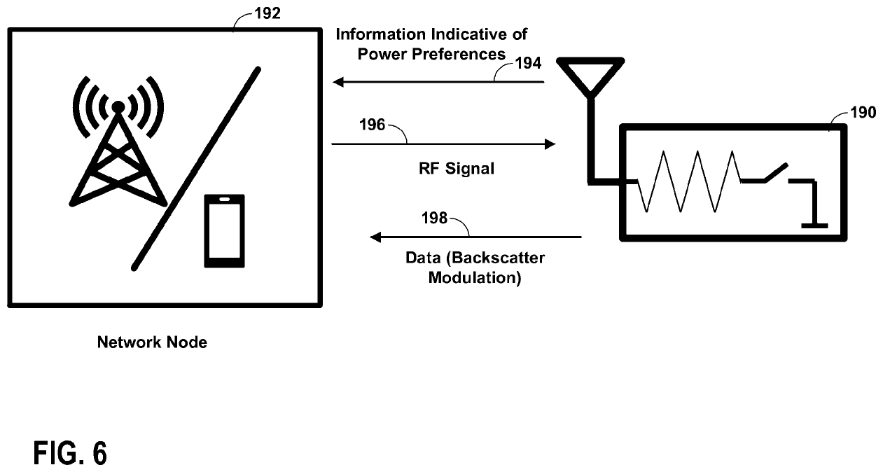

FIG. 6 is a block diagram illustrating an example technique for power control in a backscatter device in accordance with one or more aspects of the disclosure. In accordance with the techniques of this disclosure, a network node (e.g., UE 115 and/or network entity 105) may be configured to communicate with one or more backscatter devices 190. In one example, a backscatter device 190 may be configured to send, to a first network node 192, information indicative of power preferences 194 for the backscatter device 190. Examples of the information indicative of the power preferences will be described in more detail below. The backscatter device 190 may receive, from the first network node 192, an RF signal 196, wherein the RF signal 196 is based on the information 194. For example, the network node 192 may use the information indicative of the power preferences for the backscatter device 190 to determine parameters of the RF signal. Such parameters may include the power, waveform, and/or frequency of the RF signals. In other examples, the network node 192 may determine the timing and/or periodicity for sending the RF signal. The backscatter device 190 may then transmit, based on a backscatter modulation of the RF signal 196, data 198 to the network node 192 or to another network node.

The following are examples of both open loop power control and closed loop power control for the backscatter device 190 using different types of information indicative of the power preferences. In some examples, the network node 192 may perform open loop power control of the RF signal 196 without direct feedback from the backscatter device 190. In other examples, the network node 192 may perform closed loop power control that includes feedback from the backscatter device 190. Each of the techniques described below may be used alone, or may be combined with any of the other techniques in any combination. That is, each of the examples below of information indicative of power preferences should not be considered to be a mutually exclusive example.

The relationship between the power available for harvesting from RF signal 196 and the modulated backscattered power of data 198 (e.g., the total power of the two sidebands of the backscattered wave, excluding the carrier power) may be described as follows. The RF power available for DC power generation (e.g., energy harvesting) for two impedance states is given by P_{RF,in}=Pₐᵥₐᵢₗ (p₁(1−|Γ₁|²)+p₂(1−|Γ₂|²)), where P_{RF,in} is the power available for harvesting, p_{1,2} is the probability that the backscatter device 190 is in one of the two state impedance states, Γ_{1,2} is the reflection coefficient dependent on the modulation type, and Pₐᵥₐᵢₗ is the power available from the antenna of the backscatter device 190 (e.g., RF signal 196). The two impedance states correspond to a relatively high impedance and a relatively matched load, e.g., as described above with regard to ASK and OOK modulation.

The modulated backscattered power of data 198 is also dependent on the reflection coefficient and an antenna loss factor. For example, the modulated backscattered power P_{bs} may be determined as follows:

$${P}_{bs} = \frac{{P}_{avail}}{4 {L}_{ant}} {\vert {Γ}_{1} - {Γ}_{2} \vert}^{2} ,$$

where Lₐₙₜ is the antenna loss. In the foregoing, it is assumed that p₁=p₂=0.5 (i.e., each impedance state has the same probability).

Therefore, the harvested power available to the backscatter device 190 can be derived from the modulated backscattered power if the reflection coefficients are known. Accordingly, in one example of the disclosure, the information indicative of the power preferences 194 may be data that indicates the supported modulation type, the number of impedance states, and the associated reflection coefficients of the modulation types used the backscatter device 190. Backscatter device 190 may send information indicative of the supported modulation type, the number of impedance states, and the associated reflection coefficients to the network node 192.

The network node 192 may then determine the power available (P_{RF,in}) for energy harvesting by measuring the power (P_{bs}) of the backscattered signal (e.g., data 198). The network node 192 may use the power Pos and the the information indicating the modulation, impedance, and associated reflection coefficients to determine P_{RF,in} using the relationships described above. Based on the requirements of the use case for the backscatter device 190, the network node 192 may then send RF signal 196 at an appropriate power level (Pₐᵥₐᵢₗ) to meet target levels for P_{RF,in}.

For example, if the network node 192 determines that PRE in is less than some target power (P₀), then an emitter of the RF signal 196 (e.g., either network node 192 or some other separate RF source) may be configured and/or instructed to increase the transmission power for the RF signal 196 sent to the backscatter device 190. Otherwise, the network node 192 or another source may reduce the transmit power of the RF signal 196 until achieving the target power (P₀). The target power (P₀) may be communicated to the network node 192 by another network entity 105, another UE 115, or by the backscatter device 190. The foregoing is one example of open loop power control of the disclosure.

In the above example, three modulation types may be defined. One modulation type may be amplitude-shift keying (ASK) with power mismatch in one impedance state (Γ₁=0) and total reflection in the other impedance state (|Γ₂|=1). Another modulation type may be phase-shift keying (PSK) with equal mismatch in both impedance states (Γ_{1,2}=±jm). Another modulation type may be ASK with equal mismatch in both impedance states (Γ_{1,2}=±m). For the last two types, a modulation index m may be reported to the network node 192 as the reflection coefficient. The variable Γ_{1,2} represents the reflection coefficient for each impedance state defined as

$${Γ}_{1 , 2} = \frac{{Z}_{1 , 2} - {Z}_{ant}^{*}}{{Z}_{1 , 2} + {Z}_{ant}^{*}}$$

Where Z_{1,2} is the equivalent complex impedance of the backscatter devices integrated circuits, which may include a resistance and a capacitance, e.g.,
Z_{1,2}=R_{1,2}+jX_{1,2} (R_{1,2} is resistance and X_{1,2} is a capacitance with

$${X}_{1 , 2} = - \frac{1}{w \cdot {C}_{IC}} ) .$$

In another example of the disclosure, the information indicative of power preferences 194 that is sent from the backscatter device 190 to the network node 192 may include a power ratio (P_{RF,in}/P_{bs}) between a power (P_{RF,in}) available from the RF signal 196 for harvesting and a power (P_{bs}) of the backscatter modulation of the RF signal (e.g., the power of data 198). The power ratio may also be referred to as a power ratio difference.

The following are example power ratios for different modulation types. Of course, other power ratios may be used for different backscatter modulation types. For the ASK modulation type with power mismatch in the on state (Γ₁=0) and total reflection in the other state (|Γ₂|=1), 50% of the input power is available for rectification, 25% is used as backscattered modulated power and the remaining 25% is wasted. Therefore, the power ratio difference is 10*log 10 (2)=3 dB. For the PSK modulation type with equal mismatch in both states (Γ_{1,2}=±jm) and m=\sqrt{2}−1, 83% of the input RF wave power is available for rectification and 17% is used as backscattered modulated power. Therefore, the difference is 10*log 10 (83/17)=6.88 dB. For the ASK modulation type with equal mismatch in both states (Γ_{1,2}=+m) and m=\sqrt{2}−1, assuming the modulation is achieved by switching a resistor in series in one of the two states, 49% of the input RF wave power is available for rectification, 17% is used as backscattered modulated power, and the remaining 34% is wasted. Therefore, the difference is 10*log 10 (49/17)=4.6 dB.

In some examples, the backscatter device 190 is configured to directly measure P_{bs} and P_{RF,in} to determine the power ratio. In other examples, the power ratio difference can be pre-calculated based on the reflection coefficients and/or from lab measurement and the power ratio may be stored in a memory at backscatter device 190.

Network node 192 may determine the power available (P_{RF,in}) for energy harvesting by measuring the received power (P_{bs,rx}) of the backscattered signal (e.g., data 198) and then determining P_{RF,in} given the received power ratio difference. Based on the requirements of the use case for backscatter device 190, the network node 192 may then send RF signal 196 at an appropriate power level (Pₐᵥₐᵢₗ) to meet target levels for P_{RF,in}.

Again, if the network node 192 determines that P_{RF,in} is less than some target power (P₀), then an emitter of the RF signal 196 (e.g., either network node 192 or some other separate RF source) may be configured and/or instructed to increase the transmission power for the RF signal 196 sent to the backscatter device 190. Otherwise, the network node 192 or another source may reduce the transmit power of the RF signal 196 until achieving the target power (P₀). The target power (P₀) may be communicated to the network node 192 by another network entity 105, another UE 115, or by the backscatter device 190. The foregoing is another example of open loop power control of the disclosure.

As one example of using the power ratio difference, the network node 192 may determine P_{RF,in} as follows: P_{RF,in}=P_{bs,Rx}+PL+Δ, where PL is the path loss and Δ is the power ratio difference for the modulated backscattered power. In some examples, the power ratio difference may be indicated by the backscatter device 190 in information 194, as described above. In other examples, the power ratio difference may be derived by the network node 102 from the reflection coefficients and modulation types (e.g., as indicated in information 194).

In general, in the above examples of open loop power control, the network node 192 may be configured to estimate an available power of the RF signal 196 at the backscatter device 190 based on a received power of the backscatter modulation of the RF signal and the information indicative of the power preferences 194. The network node 192 may then determine a transmission power for the RF signal 196 based on the available power of the RF signal at the backscatter device 190 and based on a target power (P₀).

The following describes examples of closed-loop power control that may be used together with the open loop power control techniques described above or may be used alone.

In one example, the backscatter device 190 may send (e.g., in information 194) an indication to increase or decrease transmission power for the RF signal 196. In one example, the backscatter device 190 may be configured to measure the actually harvested power by the RF energy harvesting circuit 430 (see FIG. 4) and send an indication to increase or decrease transmission power of the RF signal 196 based on its measurement. In one example, the indication to increase or decrease transmission power may be a transmit power control (TPC) command. Referring to FIG. 4, the backscatter device 190 may further include an analog-to-digital converter (ADC) between RF energy harvesting circuit 430 and the micro controller 440 to measure the actually harvested power. As such, the support of closed-loop power control in the backscatter device 190 can be based on capability (e.g., presence of energy measuring circuitry), and would not be mandatory.

In a closed-loop power control example of the disclosure, the backscatter device 190 may be configured to measure a power of the RF signal available for harvesting, and send, to the network node 192, information indicative of a request for an increase or decrease of power for a subsequent RF signal. Again, the request may be a TPC command in some examples. Likewise, the network node 192 may be configured to receive, from the backscatter device 190, information indicative of a request for an increase or decrease of power for a subsequent RF signal, and send the subsequent RF signal to the backscatter device 190 based on the request.

In another example of the disclosure, a backscatter device with limited energy storage, such as backscatter device 190, can report, in information 194, a preferred minimum periodicity for receiving RF signal 196 based on its traffic pattern and latency requirements for device originated traffic (e.g., for sensing data transmission). The preferred pattern of receiving RF signals at the backscatter device 190 may include a minimum periodicity for receiving the RF signal, a signal time window per period, and a short periodicity for signal transmission within the window. In some examples, the preferred pattern of receiving RF signals may follow a nested outer and inner discontinuous reception (DRX) cycle as supported for the extended discontinuous reception (eDRX) pattern configuration.

EDRX is a feature in 5G cellular networks that enables devices to reduce their power consumption by extending the time between the periods of radio reception. In 5G, eDRX is used to conserve the battery life of battery-powered IoT devices that may engage in intermittent or sporadic data communication. By increasing the time between radio receptions, the device can remain in a low-power mode for longer periods of time, which ultimately leads to longer battery life. EDRX allows devices to wake up from a sleep mode only when it is necessary to receive data, rather than remaining constantly active, which can significantly reduce power consumption.

The network node 192 may transit an RF signal 196 (or RF packet) with minimum periodicity to prevent the backscatter device 190 from entering cold start. In this way, the backscatter device 190 may be more quickly waked up when there is data to transmit or receive.

In one example, the eDRX periodicity can be used as a baseline for the minimum periodicity for receiving the RF signal. In some examples, the minimum periodicity may be “power of 2” values: 5.12s, 10.24s, . . . , 2621.44s (43.69 min) or “non power of 2” values: 10.24*(6, 10, 12, 14)=61.44s, 102.4s, 122.88s, 143.36s. In some examples, when the minimum periodicity is larger than 10.24s, an energy harvesting time window per period can be defined in which RF signal 196 is transmitted with a second, smaller periodicity.

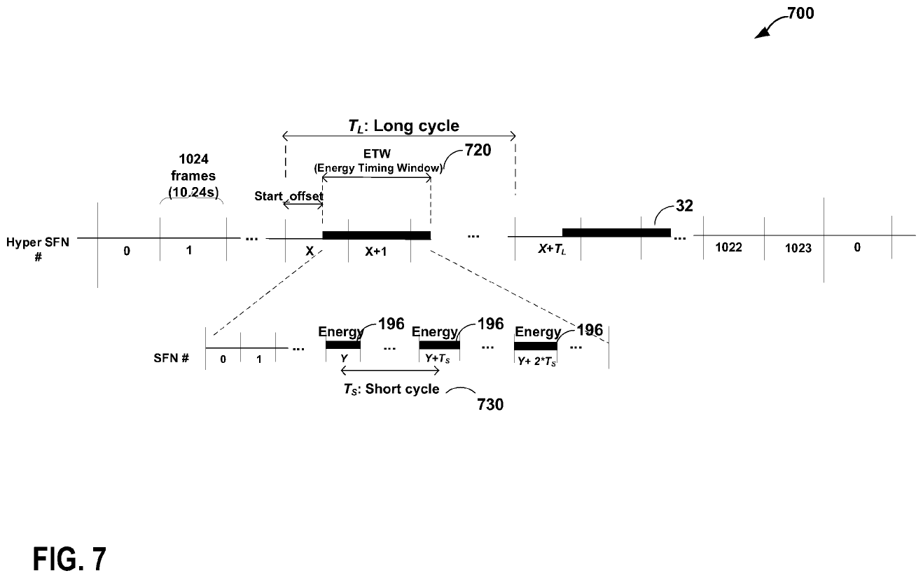

FIG. 7 is a timing diagram 700 for transmitting an RF signal for energy harvesting in accordance with one or more aspects of the present disclosure. The timing diagram shows a hyper system frame number (SFN), from 0 to 1023. Each hyper SFN includes 1024 frames in 10.24. A long cycle (T_{L}) of energy timing window (ETW) 720 (e.g., the minimum periodicity) starts at an offset from hyper SFN X. The backscatter device 190 sends information that indicates that RF signals are to be received in ETW 720. Within ETW 720, the backscatter device may further define a signal time window per period, and a short periodicity for signal transmission within the window. The signal time window per period is shown as Y, Y+Ts, Y+2*Ts, where Y is the first SFN at which RF signal 196 is received, and Ts is the time between RF signals (e.g., the short cycle 730 or short periodicity for signal transmission within the window).

As such, in this example, the information indicative of the power preferences 194 includes one or more of a preferred minimum periodicity for receiving subsequent RF signals, a signal time window per period for receiving the subsequent RF signals, or a periodicity for signal transmission within the signal time window. The network node 192 may be configured to send RF signals 196 to the backscatter device 190 at a minimum periodicity (e.g., with ETW 720). In some examples, the network node 192 may further be configured to send the RF signals within a signal time window per period (e.g., at HFN Y in FIG. 7), and/or at a short periodicity within the signal time window (e.g., based on short cycle 730).

In general, the backscatter device 190 may receive a periodic RF signal within a time window. If there is any data to transmit, the backscatter device 190 can backscatter modulate the RF signal to carry its data. If there is no data to report, then the backscatter device 190 may not backscatter modulate the RF signal. Based on the detection of the modulated backscattered signal, the network node 192 may determine whether there is data transmission from the backscatter device 190. If there is no data from the backscatter device 190, the network node 192 may stop transmission of the remaining RF signals within the time window. In other words, the time window is not only for periodic energy harvesting, but also for periodic backscattering for any device originated traffic.

In another example of the disclosure, the network node 192 may be configured to send configuration information to other RF energy emitters (e.g., other network nodes) that that includes the information indicative of the power preferences of the backscatter device 190. The information indicative of the power preferences of the backscatter device may include one or more of a DRX configuration, a duration, a frequency resource, or a zone or location of the backscatter device. In this way, more readers in proximity to backscatter device 190 may be configured to perform the power control features of this disclosure. The DRX configuration can include a minimum periodicity for transmitting the RF signal, a signal time window per period, and a short periodicity for RF signal transmission within the window.

In some examples, only readers or RF energy emitters that are within a threshold distance to the backscatter device 190 (e.g., within the indicated zone or location) are configured to transmit the RF signal 196 on the configured time or frequency resources. The location information may allow additional readers to determine how much power to use or whether to transmit at all. For example, a network node (e.g., reader) may determine that it is within a proximity (e.g., within a threshold distance) of the backscatter device based on the location of the backscatter device, and transmit the RF signal to the backscatter device based on the first network node being within the proximity of the backscatter device.

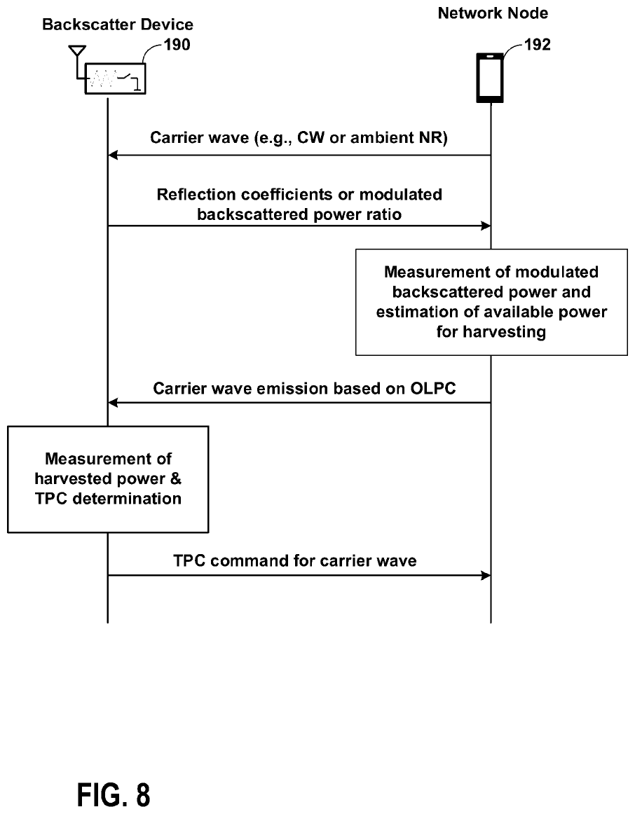

FIG. 8 is a call flow diagram illustrating an example of carrier wave emission power control in accordance with one or more aspects of the present disclosure. As shown in FIG. 8, the network node 192 may send a carrier wave (e.g., RF signal, CW, ambient NR, or the like) to the backscatter device 190. The backscatter device 190, through backscatter modulation, sends reflection coefficients and/or a modulated backscattered power ratio (e.g., in the information indicative of power preferences) to the network node 192. The network node 192 may make a measurement of the modulated backscattered power and estimate the available power for harvesting at the backscatter device 190. Based on the estimated available power for harvesting, the network node 192 may determine a power of subsequent carrier waves (e.g., RF signal 196) by comparing the estimated available power for harvesting to a target power. That is, the network node may perform carrier wave emission based on open loop power control (OLPC).

In a further example, the backscatter device 190 may also be configured to perform a measurement of harvested power and make a TPC command determination. That is the backscatter device 190 may determine to make a request to increase or decrease power of the carrier wave. The backscatter device 190 may then send a TPC command for the carrier wave to network node 192. The TPC command may be a single bit that indicates to the network node 192 to increase or decrease power. The TPC command is an example of closed loop power control (CLPC).

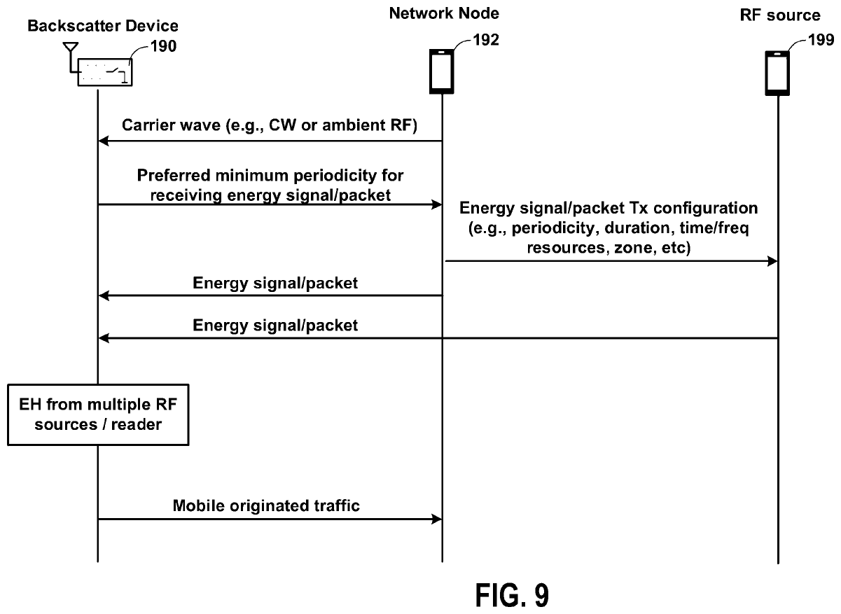

FIG. 9 is a call flow diagram illustrating another example of carrier wave emission power control in accordance with one or more aspects of the present disclosure. As shown in FIG. 9, the network node 192 may send a carrier wave (e.g., RF signal, CW, ambient NR, or the like) to the backscatter device 190. The backscatter device 190, through backscatter modulation, sends information indicative of a preferred minimum periodicity for receiving future energy signals/packets (e.g., the carrier wave, RF signal, CW, ambient NR, or the like). The network node 192 may be configured to send configuration information to other RF sources 199. The configuration information may be an energy signal/packet transmission (Tx) configuration, that includes one or more of information indicating periodicity of energy packets, duration of energy packet, time and/or frequency resources, zone (e.g., location) information, or any of the information disclosed above.

Both network node 192 and RF source 199 may send energy signals/packets to the backscatter device 190. The backscatter device 190 may perform energy harvesting from multiple RF sources and/or readers (e.g., network node 192 and RF source 199). The backscatter device 190 may then send mobile originated traffic (e.g., data) to network node 192. In this context, mobile originated traffic are backscatter transmissions that are originated from the backscatter device 190.

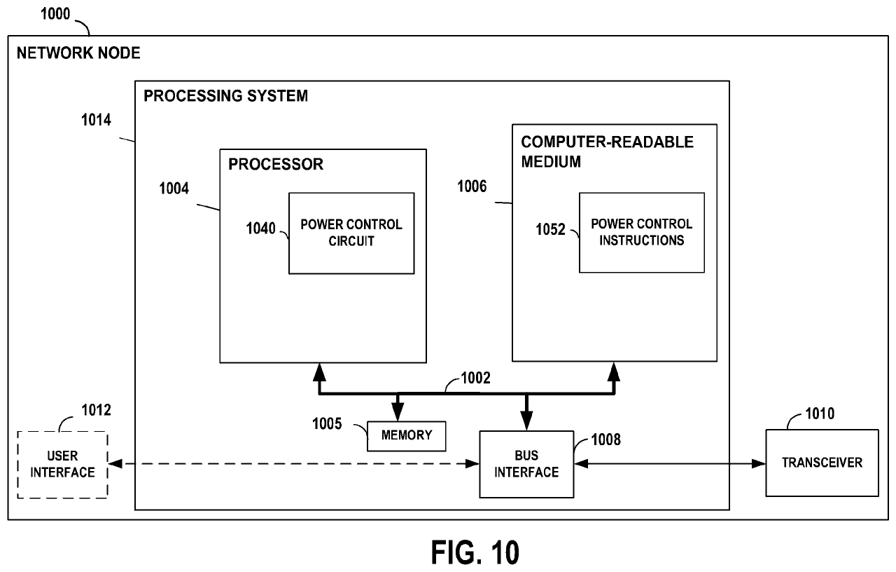

FIG. 10 is a block diagram illustrating an example of a hardware implementation for a network node 1000 (e.g., a UE 115 and/or a network entity 105) employing a processing system 1014. For example, the network node 1000 may be a UE 115 and/or a network entity 105 as illustrated in FIG. 1.

The network node 1000 may include a processing system 1014 having one or more processors 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network node 1000 may be configured to perform any one or more of the functions described herein. For example, the processor 1004, as utilized in a network node 1000, may be configured (e.g., in coordination with the memory 1005) to implement any one or more of the processes and procedures for open loop and/or closed loop power control of a backscatter device as described above.

The processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010. The transceiver 1010 provides a communication interface or means for communicating with various other apparatus over a transmission medium. Depending upon the nature of the apparatus, a user interface 1012 (e.g., keypad, display, speaker, microphone, joystick) may also be provided. Of course, such a user interface 1012 is optional, and some examples, such as a base station, may omit it.

In some aspects of the disclosure, the processor 1004 may include a power control circuit 1040 configured (e.g., in coordination with the memory 1005) for various functions, including, e.g., open loop and/or closed loop power control of a backscatter device in accordance with the techniques of the disclosure described herein. In general, the network node 1000 may be configured to receive, from a backscatter device, information indicative of power preferences for the backscatter device. The network node 1000 may send, to the backscatter device, an RF signal, wherein the RF signal is based on the information, and receive data from the backscatter device based on a backscatter modulation of the RF signal by the backscatter device.

The processor 1004 is responsible for managing the bus 1002 and general processing, including the execution of software stored on the computer-readable medium 1006. The software, when executed by the processor 1004, causes the processing system 1014 to perform the various functions described above for any particular apparatus. The processor 1004 may also use the computer-readable medium 1006 and the memory 1005 for storing data that the processor 1004 manipulates when executing software.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006. The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1006 may store computer-executable code that includes power control instructions 1052 configured for various functions, including, e.g., open loop and/or closed loop power control of a backscatter device in accordance with the techniques of the disclosure described herein. The power control instructions 1052 may be configured to cause the network node 1000 to receive, from a backscatter device, information indicative of power preferences for the backscatter device, send, to the backscatter device, an RF signal, wherein the RF signal is based on the information, and receive data from the backscatter device based on a backscatter modulation of the RF signal by the backscatter device.

In one configuration, an apparatus for wireless communication includes means for receiving, from a backscatter device, information indicative of power preferences for the backscatter device, means for sending, to the backscatter device, an RF signal, wherein the RF signal is based on the information, and means for receiving data from the backscatter device based on a backscatter modulation of the RF signal by the backscatter device. In one aspect, the aforementioned means may be the processor 1004, including power control circuit 1040, configured to perform the functions recited by the aforementioned means. In another aspect, the aforementioned means may be a circuit or any apparatus configured to perform the functions recited by the aforementioned means.

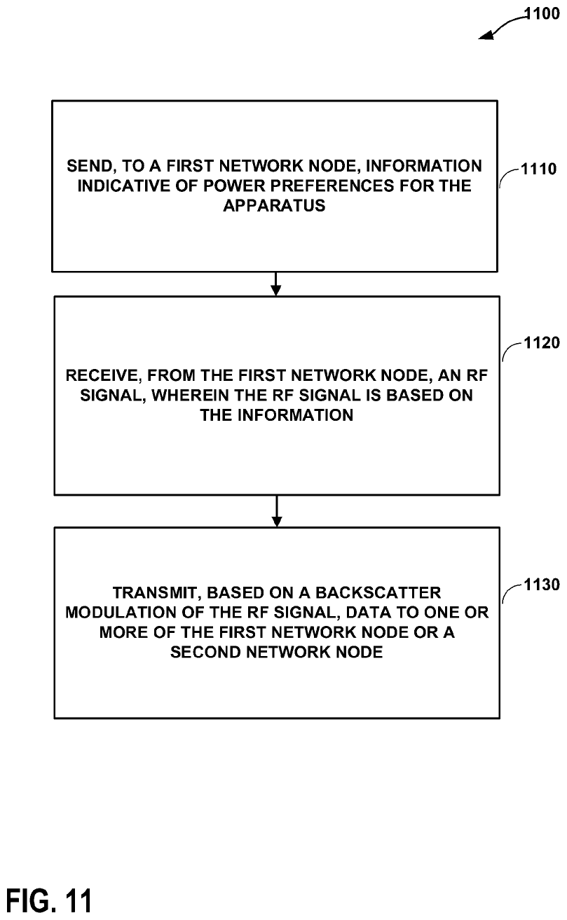

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS., and utilizing, for example, the processes and/or algorithms described above and described below in relation to FIGS. 11 and/or 12.

FIG. 11 is a flow chart illustrating an exemplary process 1100 for power control in a backscatter device. The techniques of process 1100 may be performed by the backscatter device 190 described herein.

In one example, the backscatter device 190 may be configured to send, to a first network node (e.g., UE 115 and/or network entity 105), information indicative of power preferences for the apparatus (1110). The backscatter device 190 may further receive, from the first network node, an RF signal, wherein the RF signal is based on the information (1120). The backscatter device 190 may also transmit, based on a backscatter modulation of the RF signal, data to one or more of the first network node or a second network node (1130).

In one example, the information indicative of the power preferences includes one or more of a supported modulation type, a number of impedance states, or a power reflection coefficient.

In another example, the information indicative of the power preferences includes a ratio between a first power available from the RF signal and a second power of the backscatter modulation of the RF signal.

In another example, the backscatter device 190 is further configured to measure a power of the RF signal, and send, to the first network node, information indicative of a request for an increase or decrease of power for a subsequent RF signal.

In another example, the information indicative of the power preferences includes one or more of a preferred minimum periodicity for receiving subsequent RF signals, a signal time window per period for receiving the subsequent RF signals, or a periodicity for signal transmission within the signal time window.

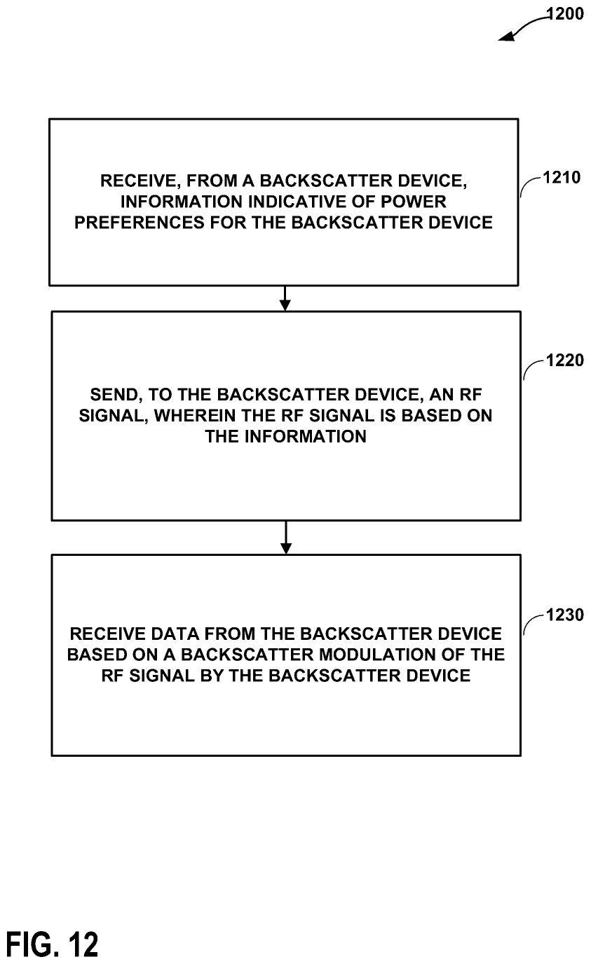

FIG. 12 is a flow chart illustrating an exemplary process 1200 for power control in a backscatter device. The techniques of process 1200 may be performed by a network node 192 described herein, such as a UE 115 and/or network entity 105.

In one example, the network node 192 may be configured to receive, from a backscatter device, information indicative of power preferences for the backscatter device (1210). The network node 192 may send, to the backscatter device, a radio frequency (RF) signal, wherein the RF signal is based on the information (1220), and receive data from the backscatter device based on a backscatter modulation of the RF signal by the backscatter device (1230).

In one example, the information indicative of the power preferences includes one or more of a supported modulation type, a number of impedance states, or a power reflection coefficient.

In another example, the information indicative of the power preferences includes a ratio between a first power available from the RF signal and a second power of the backscatter modulation of the RF signal.

In another example, the network node 192 is further configured to estimate an available power of the RF signal at the backscatter device based on a received power of the backscatter modulation of the RF signal and the information indicative of the power preferences. The network node 192 may also determine a transmission power for the RF signal based on the available power of the RF signal at the backscatter device and based on a target power.

In another example, the network node 192 is further configured to receive, from the backscatter device, information indicative of a request for an increase or decrease of power for a subsequent RF signal, and send the subsequent RF signal to the backscatter device based on the request.

In another example, the information indicative of the power preferences includes one or more of a preferred minimum periodicity for receiving subsequent RF signals, a signal time window per period for receiving the subsequent RF signals, or a periodicity for signal transmission within the signal time window. In this example, the network node 192 is configured to send, to the backscatter device, one or more subsequent RF signals to the backscatter device based on the information.

In another example, the network node 192 is a first network node, and is further configured to receive, from one or more second network nodes, configuration information that includes the information indicative of the power preferences of the backscatter device. In this example, the information indicative of the power preferences of the backscatter device includes one or more of a DRX configuration, a duration, a frequency resource, or a location of the backscatter device. The network node may be further configured to determine that the first network node is within a proximity of the backscatter device based on the location of the backscatter device and transmit the RF signal to the backscatter device based on the first network node being within the proximity of the backscatter device.

The following numbered clauses illustrate one or more aspects of the devices and techniques described in this disclosure.

Aspect 1—An apparatus for passive wireless communication, the apparatus comprising: one or more processors, and a memory accessible by the one or more processors, wherein the one or more processors are configured to: send, to a first network node, information indicative of power preferences for the apparatus; receive, from the first network node, a radio frequency (RF) signal, wherein the RF signal is based on the information; and transmit, based on a backscatter modulation of the RF signal, data to one or more of the first network node or a second network node.

Aspect 2—The apparatus of Aspect 1, wherein the information indicative of the power preferences includes one or more of a supported modulation type, a number of impedance states, or a power reflection coefficient.

Aspect 3—The apparatus of any of Aspects 1-2, wherein the information indicative of the power preferences includes a ratio between a first power available from the RF signal and a second power of the backscatter modulation of the RF signal.

Aspect 4—The apparatus of any of Aspects 1-3, wherein the one or more processors are further configured to: measure a power of the RF signal; and send, to the first network node, information indicative of a request for an increase or decrease of power for a subsequent RF signal.

Aspect 5—The apparatus of any of Aspects 1-4, wherein the information indicative of the power preferences includes one or more of a preferred minimum periodicity for receiving subsequent RF signals, a signal time window per period for receiving the subsequent RF signals, or a periodicity for signal transmission within the signal time window.

Aspect 6—The apparatus of any of Aspects 1-5, wherein the first network node is a reader.

Aspect 7—The apparatus of Aspect 6, wherein the reader is one or more of a user equipment (UE) or a base station.

Aspect 8—The apparatus of any of Aspects 1-7, wherein the RF signal is a continuous wave.

Aspect 9—The apparatus of any of Aspects 1-8, wherein the apparatus is a passive or semi-passive backscatter device.

Aspect 10-A network node for passive wireless communication, the network node comprising: one or more processors, and a memory accessible by the one or more processors, wherein the one or more processors are configured to: receive, from a backscatter device, information indicative of power preferences for the backscatter device; send, to the backscatter device, a radio frequency (RF) signal, wherein the RF signal is based on the information; and receive data from the backscatter device based on a backscatter modulation of the RF signal by the backscatter device.

Aspect 11—The network node of Aspect 10, wherein the information indicative of the power preferences includes one or more of a supported modulation type, a number of impedance states, or a power reflection coefficient.

Aspect 12—The network node of any of Aspects 10-11, wherein the information indicative of the power preferences includes a ratio between a first power available from the RF signal and a second power of the backscatter modulation of the RF signal.

Aspect 13—The network node of any of Aspects 10-12, wherein the one or more processors are further configured to: estimate an available power of the RF signal at the backscatter device based on a received power of the backscatter modulation of the RF signal and the information indicative of the power preferences.

Aspect 14—The network node of Aspect 13, wherein the one or more processors are further configured to: determine a transmission power for the RF signal based on the available power of the RF signal at the backscatter device and based on a target power.

Aspect 15—The network node of any of Aspects 10-14, wherein the one or more processors are further configured to: receive, from the backscatter device, information indicative of a request for an increase or decrease of power for a subsequent RF signal; and send the subsequent RF signal to the backscatter device based on the request.

Aspect 16—The network node of any of Aspects 10-15, wherein the information indicative of the power preferences includes one or more of a preferred minimum periodicity for receiving subsequent RF signals, a signal time window per period for receiving the subsequent RF signals, or a periodicity for signal transmission within the signal time window, and wherein the one or more processors are configured to: send, to the backscatter device, one or more subsequent RF signals to the backscatter device based on the information.

Aspect 17—The network node of any of Aspects 10-16, wherein the network node is a first network node, and wherein the one or more processors are further configured to:

receive, from one or more second network nodes, configuration information that includes the information indicative of the power preferences of the backscatter device.

Aspect 18—The network node of Aspect 17, wherein the information indicative of the power preferences of the backscatter device includes one or more of a DRX configuration, a duration, a frequency resource, or a location of the backscatter device.

Aspect 19—The network node of Aspect 18, wherein the one or more processors are further configured to: determine that the first network node is within a proximity of the backscatter device based on the location of the backscatter device; and transmit the RF signal to the backscatter device based on the first network node being within the proximity of the backscatter device.

Aspect 20—The network node of any of Aspects 10-19, wherein the first network node is a reader.

Aspect 21—The network node of Aspect 20, wherein the reader is one or more of a user equipment (UE) or a base station.

Aspect 22—The network node of any of Aspects 10-21, wherein the RF signal is a continuous wave.

Aspect 23—The network node of any of Aspects 10-22, wherein the backscatter device is a passive or semi-passive backscatter device.

Aspect 24-A method for passive wireless communication by a backscatter device, the method comprising: sending, to a first network node, information indicative of power preferences for the backscatter device; receiving, from the first network node, a radio frequency (RF) signal, wherein the RF signal is based on the information; and transmitting, based on a backscatter modulation of the RF signal, data to one or more of the first network node or a second network node.

Aspect 25—The method of Aspect 24, wherein the information indicative of the power preferences includes one or more of a supported modulation type, a number of impedance states, or a power reflection coefficient.

Aspect 26—The method of any of Aspects 24-25, wherein the information indicative of the power preferences includes a ratio between a first power available from the RF signal and a second power of the backscatter modulation of the RF signal.

Aspect 27-A method for passive wireless communication, the method comprising: receiving, from a backscatter device, information indicative of power preferences for the backscatter device; sending, to the backscatter device, a radio frequency (RF) signal, wherein the RF signal is based on the information; and receiving data from the backscatter device based on a backscatter modulation of the RF signal by the backscatter device.

Aspect 28—The method of Aspect 27, further comprising: estimating an available power of the RF signal at the backscatter device based on a received power of the backscatter modulation of the RF signal and the information indicative of the power preferences.

Aspect 29—The method of Aspect 28, further comprising:

determining a transmission power for the RF signal based on the available power of the RF signal at the backscatter device and based on a target power.

Aspect 30—The method of any of Aspects 27-29, further comprising: receiving, from the backscatter device, information indicative of a request for an increase or decrease of power for a subsequent RF signal; and sending the subsequent RF signal to the backscatter device based on the request.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at different locations, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for passive wireless communication, the apparatus comprising:
one or more processors; and
a memory accessible by the one or more processors, wherein the one or more processors are configured to:
send, to a first network node, information indicative of power preferences for the apparatus;
receive, from the first network node, a radio frequency (RF) signal, wherein the RF signal is based on the information; and
transmit, based on a backscatter modulation of the RF signal, data to one or more of the first network node or a second network node.

2. The apparatus of claim 1, wherein the information indicative of the power preferences includes one or more of a supported modulation type, a number of impedance states, or a power reflection coefficient.

3. The apparatus of claim 1, wherein the information indicative of the power preferences includes a ratio between a first power available from the RF signal and a second power of the backscatter modulation of the RF signal.

4. The apparatus of claim 1, wherein the one or more processors are further configured to:
measure a power of the RF signal; and
send, to the first network node, information indicative of a request for an increase or decrease of power for a subsequent RF signal.

5. The apparatus of claim 1, wherein the information indicative of the power preferences includes one or more of a preferred minimum periodicity for receiving subsequent RF signals, a signal time window per period for receiving the subsequent RF signals, or a periodicity for signal transmission within the signal time window.

6. The apparatus of claim 1, wherein the first network node is a reader.

7. The apparatus of claim 6, wherein the reader is one or more of a user equipment (UE) or a base station.

8. The apparatus of claim 1, wherein the RF signal is a continuous wave.

9. The apparatus of claim 1, wherein the apparatus is a passive or semi-passive backscatter device.

10. A network node for passive wireless communication, the network node comprising:
one or more processors; and
a memory accessible by the one or more processors, wherein the one or more processors are configured to:
receive, from a backscatter device, information indicative of power preferences for the backscatter device;
send, to the backscatter device, a radio frequency (RF) signal, wherein the RF signal is based on the information; and
receive data from the backscatter device based on a backscatter modulation of the RF signal by the backscatter device.

11. The network node of claim 10, wherein the information indicative of the power preferences includes one or more of a supported modulation type, a number of impedance states, or a power reflection coefficient.

12. The network node of claim 10, wherein the information indicative of the power preferences includes a ratio between a first power available from the RF signal and a second power of the backscatter modulation of the RF signal.

13. The network node of claim 10, wherein the one or more processors are further configured to:
estimate an available power of the RF signal at the backscatter device based on a received power of the backscatter modulation of the RF signal and the information indicative of the power preferences.

14. The network node of claim 13, wherein the one or more processors are further configured to:
determine a transmission power for the RF signal based on the available power of the RF signal at the backscatter device and based on a target power.

15. The network node of claim 10, wherein the one or more processors are further configured to:
receive, from the backscatter device, information indicative of a request for an increase or decrease of power for a subsequent RF signal; and
send the subsequent RF signal to the backscatter device based on the request.

16. The network node of claim 10, wherein the information indicative of the power preferences includes one or more of a preferred minimum periodicity for receiving subsequent RF signals, a signal time window per period for receiving the subsequent RF signals, or a periodicity for signal transmission within the signal time window, and wherein the one or more processors are configured to:
send, to the backscatter device, one or more subsequent RF signals to the backscatter device based on the information.

17. The network node of claim 10, wherein the network node is a first network node, and wherein the one or more processors are further configured to:
receive, from one or more second network nodes, configuration information that includes the information indicative of the power preferences of the backscatter device.

18. The network node of claim 17, wherein the information indicative of the power preferences of the backscatter device includes one or more of a discontinuous reception (DRX) configuration, a duration, a frequency resource, or a location of the backscatter device.

19. The network node of claim 18, wherein the one or more processors are further configured to:
determine that the first network node is within a proximity of the backscatter device based on the location of the backscatter device; and
transmit the RF signal to the backscatter device based on the first network node being within the proximity of the backscatter device.

20. The network node of claim 10, wherein the network node is a reader.

21-30. (canceled)
